(19) United States
(12) Patent Application Publication
(10) Pub. No.: US 2008/0115124 A1
(43) Pub. Date: May 15, 2008

(54) TRIAL MODE FOR SELECTIVELY TRYING A COMPONENT THAT ADDS FUNCTIONALITY TO BASE SOFTWARE

(75) Inventor: Jeff Remer, San Francisco, CA (US)

Correspondence Address: CHARLES J. KULAS, 651 ORIZABA AVE., SAN FRANCISCO, CA, 94132, US

(73) Assignee: Charles J. Kulas, San Francisco, CA (US)

(21) Appl. No.: 11/558,891

(22) Filed: Nov. 10, 2006

(51) Int. Cl. G06F 9/445; G06F 3/048

(52) U.S. Cl. 717/178; 715/810

(57) ABSTRACT

A software component can be selectively tried without requiring standard installation. In a specific embodiment, a user can selectively try various components before incorporation of the components into base software. The exemplary method includes activating base software that is adapted for use with one or more components; providing a first user option to employ a first component with the base software in a first mode of operation; providing a second user option to employ the first component with the base software in a second mode of operation; and using the first component according to the first mode of operation or according to the second mode of operation based on whether the first user option or the second user option is selected.

### BACKGROUND OF THE INVENTION

This invention is related in general to computing and more specifically relates to systems and methods for providing user options to control how software features are implemented or executed.

Systems and methods for controlling how software is implemented or executed are employed in various applications including software installation wizards, which may provide various user options, such as installation directory, components to install, and so on. Such applications demand user-friendly systems and methods for allowing users to control how and where software is executed within a computer or network.

Unfortunately, existing systems and methods for controlling how software is implemented or executed often lack sufficient functionality or versatility to enable a user to optimize how the software is used, tried, installed, or executed. Consequently, such systems and methods often result in undesired or unused components being installed or loaded into computer memory.

### BRIEF DESCRIPTION OF THE DRAWINGS

FIG. 1 is a flow diagram of a method for selectively trying or installing software according to an embodiment of the present invention.

FIG. 2 is a diagram illustrating a first screen of an exemplary user interface that is adapted for use with the method of FIG. 1 and which provides a user option to try or install one or more components, such as a searchlet, and to install base software, such as searchlet-management software.

FIG. 3 is a diagram illustrating a second screen of the exemplary user interface of FIG. 1 after installation of the searchlet-management software and an accompanying tool bar.

FIG. 4 is a diagram illustrating an instance of the second screen of FIG. 3, showing selectable searchlets listed in a pull-down menu in preparation for trying one or more of the searchlets in accordance with the method of FIG. 1.

FIG. 5 is a diagram illustrating a fourth screen, which is accessed via the screen of FIG. 4, for trying a shopping searchlet.

FIG. 6. is a diagram illustrating a fifth screen that appears when a user chooses to install the shopping searchlet, such as from the fourth screen of FIG. 5.

FIG. 7 is a diagram illustrating a sixth screen and accompanying searchlet menu option that is accessible from the tool bar after installing the shopping searchlet from the third screen of FIG. 4.

FIG. 8 is a diagram of a system that employs a client and a remote searchlet repository for implementing the method of FIG. 1 and accompanying screens of FIGS. 2-7.

FIG. 9 is a flow diagram of a method employed by the client of FIG. 8 in response to a request to try or install a searchlet component or to apply a searchlet to a document.

FIG. 10 is a flow diagram of a method employed by the remote searchlet repository or local searchlet repository and accompanying loader of FIG. 8 in response to a request from the client of FIG. 8.

FIG. 11 is a use-case diagram illustrating various functionality implemented or employed by various modules of the system of FIG. 8.

### DETAILED DESCRIPTION OF EMBODIMENTS OF THE INVENTION

A preferred embodiment of the present invention implements a system and method for facilitating selecting an operational mode for code and then running the code according to the operational mode. For the purposes of the present discussion, code may be any software, computer hardware, and/or firmware.

The system includes a first mechanism for activating base software that is adapted for use with one or more components. A second mechanism provides a first user option to use a first component in a first mode of operation. A third mechanism provides a second user option to use the first component with the base software in a second mode of operation. A fourth mechanism uses the first component according to the first mode of operation or the second mode of operation based on output from the second mechanism or the third mechanism.

In a more specific embodiment, the first mode of operation includes a trial mode, and the second mode of operation includes an install mode. For the purposes of the present discussion, a trial mode may be any mode wherein a user may use a software/hardware component, module, or package in accordance with certain trial rules that selectively limit usage of the software/hardware component, module, or package. In the specific embodiment, the trial mode is characterized by an automatic expiration of a predetermined trial period.

The trial mode may be further characterized by expiration of trial period if the first component is not used a predetermined number of times during a predetermined interval. In addition, the trial mode may automatically switch to install mode, thereby triggering automatic installation of a component, when the first component is used a predetermined number of times over a predetermined time period.

An install mode may be any mode wherein a software/hardware component, module, or package is installed or otherwise made accessible without limitations placed upon the duration of use of the particular software/hardware component, module, or package.

The first component can include any code, script, program or other functional text or information. In an example embodiment, components include a “searchlet” which adds functionality to existing software, such as to a search engine interface. A searchlet may be any piece of code, such as a hardware and/or software component, that facilitates performing a search of a document or other data in accordance with certain search rules. Although embodiments of the invention are primarily discussed with reference to a searchlet as the component, any other type of component may be used.

The first mechanism includes a client, which includes a browser, which communicates with a server. The trial mode includes a mode wherein the first component is usable on a trial basis without requiring that the first component be installed on the client as part of the base software. In this trial mode, the first component is said to run server side. Similarly, a component that is stored on and runs on a client is said to run client-side.

A fourth mechanism provides a user option to adjust one or more usage parameters associated with the first mode of operation, i.e., the trial mode. The usage parameters affect a trial period for use of the first component.

The first component includes one or more components implemented via one or more software extensions, such as Firefox extensions. A Firefox extension may be any mechanism within the Mozilla Firefox browser that enables implementation of one or more software components therein or thereby.

Certain embodiments of the present invention are particularly useful in Internet-based searching applications, where various software components, such as searchlets, may be needed once, but installed and never used again. The installation and loading of unused components represents inefficient use of system resources.

Other useful applications include operating system loading and installing applications. For example, an embodiment of the present invention may obviate the need for an operating system to load all components into memory each time an operating system is run. Loading all components into memory may hog memory, making the computer slower. This is especially problematic when certain large components, which are not used, are loaded each time the operating system is loaded. Implementation of a trial mode, in accordance with an embodiment of the present invention, allows a user to better decide whether they want to install and/or load certain components each time the software is activated or used.

For clarity, various well-known components, such as power supplies, modems, firewalls, network cards, Internet Service Providers (ISPs), and so on, have been omitted from the figures. However, those skilled in the art with access to the present teachings will know which components to implement and how to implement them to meet the needs of a given application.

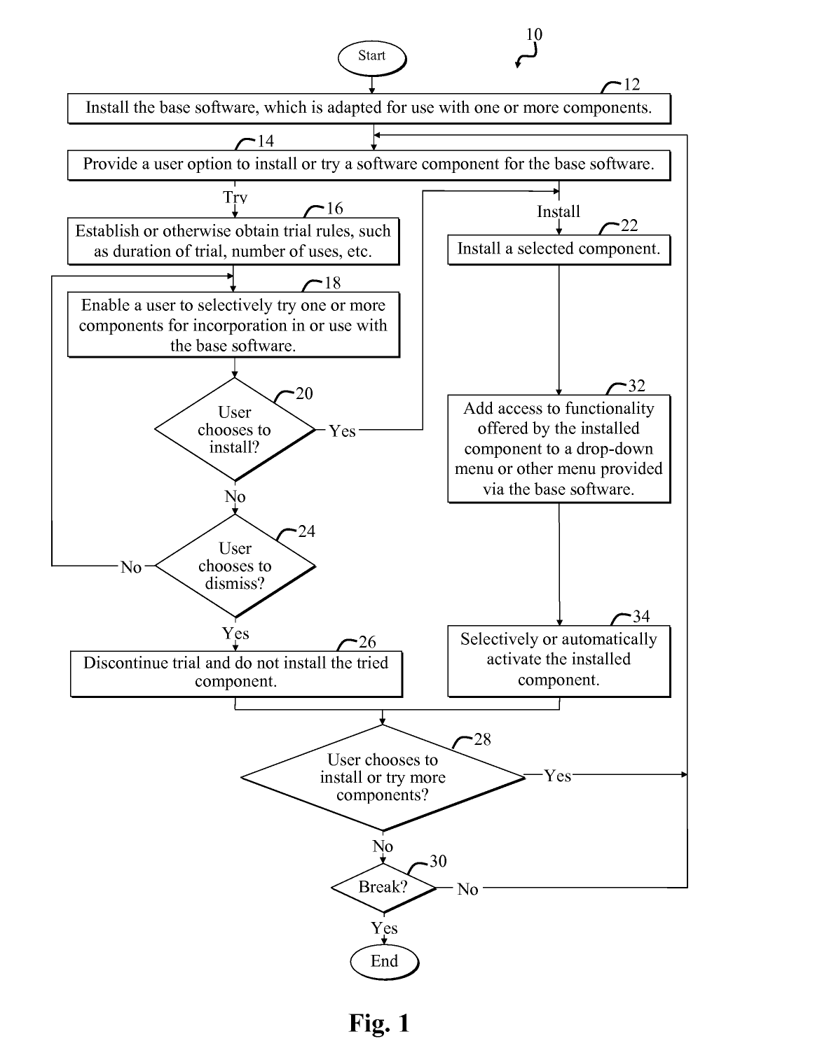

FIG. 1 is a flow diagram of a method 10 according to an embodiment of the present invention. The method 10 includes a first step 12, wherein base software is installed on a computer, such as a client. For the purposes of the present discussion, a client may be any device that receives information from a network, such as from a server in the network, such as in response to a query or a push from the server to the client. Base software may be any software that is adapted for use with components that expand or otherwise affect the functionality of the base software.

A software component may be any software or code or piece thereof. A server may be any computer program, which may be implemented in hardware and/or software, that can provide data and/or functions to another network entity, such as another program or module, in response to a query from the other program or module or via a push to the other program or module.

A second step 14 includes providing a user option to try or otherwise install a software component for use with the base software. If the user elects to try the software component, then a trial-rules step 16 is performed.

The trial-rules step 16 includes determining trial rules that govern how the software component will be used. Trial rules may be any parameters or other information that govern a trial mode of operation. Examples of trial rules include trial duration times, rules defining how many uses of trial software may be allowed before the trial software is disabled or uninstalled, and so on. Exact trial rules are application specific.

A trial mode may be any mode of operation that is affected by parameters, such as trial rules, that limit the accessibility or usage of the associated code. An install mode may be any mode that is not affected by accessibility limits associated with a trial mode.

In a subsequent try-mode step 18, a user selectively tries a software component. If after or while trying the software component in the try-mode step 18, the user decides to install the software component, such as in a first choosing step 20, then an installation step 22 is performed, wherein the software component is installed. After installation of the software component, the software component is then available or accessible through the base software. The installation step 22 is also initiated if in the second step 14, a user chooses to install the software component instead of trying it.

If in the first choosing step 20, the user does not choose to install the software component that is currently being used on a trial basis, then a second choosing step 24 is performed. The second choosing step 24 includes determining if the user has chosen to dismiss the software component or not. If the user does not dismiss the software component, then the try-mode step 18 continues. Otherwise a discontinuing step 26 is performed. The discontinuing step 26 involves discontinuing use of and unloading of the software component that is being used on a trial basis.

If in the second step 14, the user chooses to install the software component, then the software component is installed in the installing step 22. A subsequent accessing step 32 involves adding access to functionality provided by the software component via the base software, such as by adding a menu item in a drop-down menu that may be used to activate the software component.

Subsequently, an activating step 34 involves selectively or automatically activating the installed software component. Automatic activation may involve automatically applying the software component to a document, such as a webpage.

After the activating step 34 and the discontinuing step 26, a third choosing step 28 is performed. The third choosing step 28 involves providing a user option to chose to install or try one or more software components. If the user chooses to try or install another software component, then the second step 14 is performed. Otherwise, a break-checking step 30 is performed.

The break-checking step 30 includes determining whether a system break has occurred. A system break may occur when the computer or other machine running code for implementing the method 10 is turned off, or if the code is otherwise disabled or exited. If a system break occurs, the method 10 completes. Otherwise, the second step 14 continues.

Note that various steps 12-34 of the method 10 may be omitted, changed, or reordered, or additional steps may be inserted, without departing from the scope of the present invention. For example, an additional step enabling the user to select desired operating parameters for installed software may be provided before or after the installation step 22. Furthermore, the trial-rules step 16 may include allowing a user to specify trial rules; the choosing steps 20 and 24 may be interchanged or omitted; and so on. An additional step may provides a user option to control whether a software component is executed client side or server side.

As another example, the method 10 may be replaced with a more generalized method that involves activating base software that is adapted for use with one or more components; providing a first user option to use a first component in a first mode of operation; providing a second user option to use the first component with the base software in a second mode of operation; and using the first component according to the first mode of or operation or the second mode of operation based on output from the second means or the third means. Furthermore, certain steps may occur simultaneously without departing from the scope of the present invention

Note that in the present specific embodiment, when a particular software component is tried, the software component is run on a server that communicates with the client that runs the base software. In this embodiment, the software component is said to run server-side during trial mode. Other ways to run the software component are possible. For example, the component can be temporarily loaded on the client and automatically unloaded after the trial (client-side) or it can be run with limited functionality on the server (server-side). In general, the timing and location of executing components or other functionality can vary, as desired, in different embodiments.

When the software component is installed, the software component is installed on the client computer and runs on the client computer as an extension to a browser that runs on the client. The browser may be Mozilla Firefox, and the extension may be a Firefox extension.

Alternatively, when the software component is tried, the software component may actually be installed on the client. In this case, the software component operates client side in accordance with the trial rules. When the software component is used on an install basis, i.e., a non-trial basis, the software component is installed on the client, but the software component does not operate or run with the limits imposed by trial rules.

For the purposes of the present discussion, use of code on a non-trial basis may be any use that is not restricted by accessibility limits associated with a trial mode.

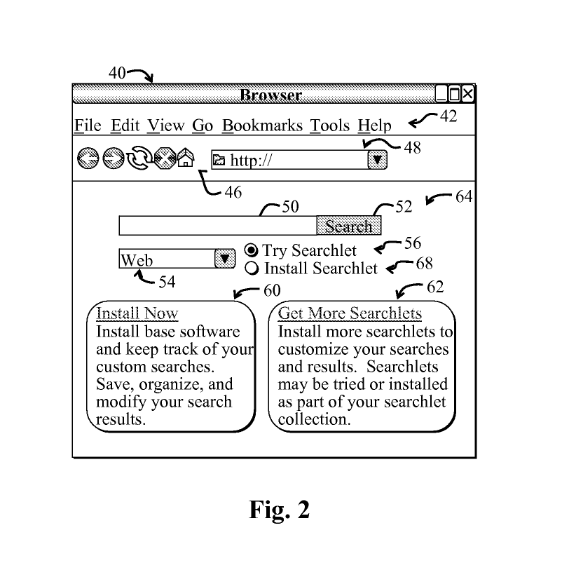

FIG. 2 is a diagram illustrating a first screen 40 of an exemplary user interface that is adapted for use with the method 10 of FIG. 1 and which provides a user option to try or install one or more searchlets and to install searchlet-management software. The searchlet-management software is called base software herein. The base software may be implemented as a browser extension, such as a Firefox extension. Furthermore, the software components for use with the base software may be implemented via a sub-extensions.

For the purposes of the present discussion, a software extension may be any software component that is adapted to add functionality to preexisting software. A sub-extension may be any component that is incorporated within or otherwise used by another component to provide certain functionality thereto.

The first screen 40, which is implemented via a browser, such as Mozilla Firefox, includes various menus 42 in a menu bar, which includes file, edit, view, go, bookmarks, tools, and help menus. A browsing toolbar, which includes various browsing buttons 46 and a Uniform Resource Locator (URL) field 48, is positioned below the menus 42.

In the present specific embodiment, a webpage 64 is loaded in the first screen 40. The webpage 64 is adapted for use with embodiments of the present invention and includes a search field 50 and an accompanying search button 52. The webpage 64 further includes a first searchlet pull-down menu 54 and corresponding radio buttons 56, 68, including a try-searchlet option 56 and an install-searchlet option 68. The searchlet options 56, 68 may be implemented via another type of user interface feature (other than radio buttons) without departing from the scope of the present invention. For example, the searchlet options 56, 68 may be implemented via an additional pull-down menu, also called a drop-down list. The webpage 64 further includes an install-now link 60 and a get-more-searchlets link 62. Other embodiments can provide components such as searchlets in other ways. For example, a list of components available for installation or trial can be provided and a user can select a component for trial from the list.

In operation, a user may select a searchlet via the drop-down list 54. The selected searchlet is applied to a search (or is applied search results returned therefrom). The search is implemented based on the search field 50 and in response to selecting the search button 52. The user selects to either try the searchlet by selecting the try-searchlet radio button 56, or the user selects to install the searchlet, which was selected via the pull-down menu 54, by choosing the install-searchlet radio button 68.

Upon typing a word or phrase in the search field 50 and then selecting the search button 52, the searchlet selected via the searchlet pull-down menu 54 is either applied to search results or affects the search itself in accordance with predetermined rules that are implemented via the selected searchlet. The selected searchlet is used on a trial basis or installed and used as part of a base software to selectively affect search results. The base software may be downloaded by following the install-now link 60. A user may access additional searchlets, such as searchlets that are not available in the searchlet pull-down menu 54, by following the get-more-searchlets link 62.

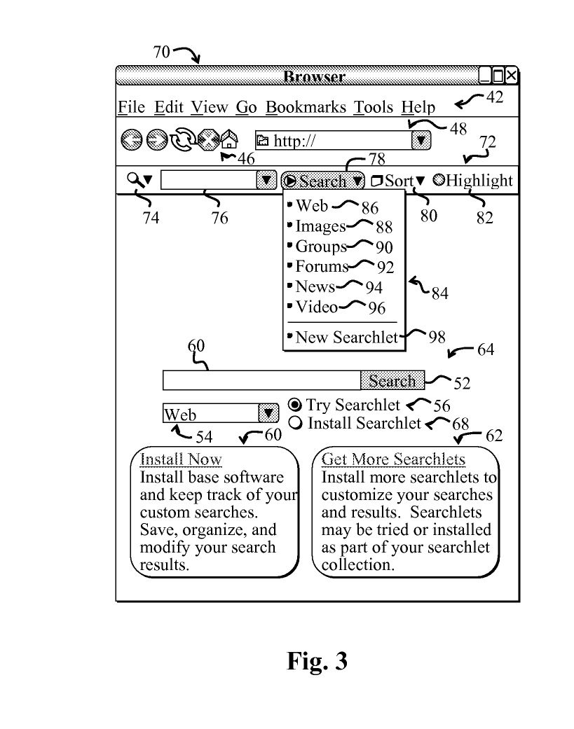

FIG. 3 is a diagram illustrating a second screen 70 of the exemplary user interface of FIG. 1 after installation of the base software, i.e., searchlet-management software, which is depicted graphically via a first tool bar 72. The first toolbar 72 includes various functionality, which is illustrated graphically via a first pull-down menu 74, a second pull-down menu 76, a search pull-down menu 78, a sort pull-down menu 80, and a highlight option 82. Various menus, such as the first pull-down menu 74, the second pull-down menu 76, the sort menu 80, and the highlight option 82 may be omitted without departing from the scope of the present invention. In the second screen 70, the search menu 78 has been selected, and a searchlet list 84 of exemplary installed searchlets 86-96 is shown. Note that a user may choose to search for new searchlets by selecting a new-searchlet option 98 in the searchlet list 84.

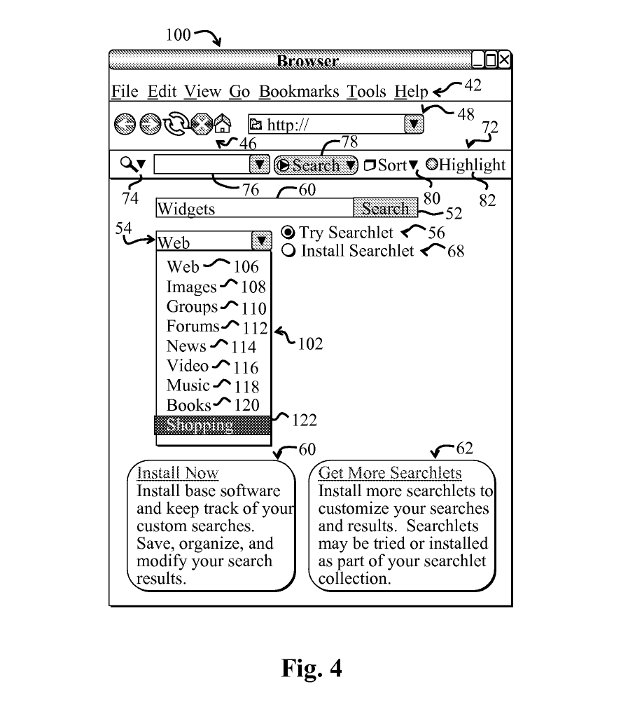

FIG. 4 is a diagram illustrating a third screen 100, which represents an instance of the second screen 70. The third screen 100 shows selectable searchlets 102, which are listed in the first searchlet pull-down menu 54, in preparation for trying one or more of the searchlets in accordance with the method of FIG. 1. The selectable searchlets 102 include various searchlets 106-116, which are similar to the searchlets 86-96, respectively, of the searchlet list 84 of FIG. 3. The selectable searchlets 102 further include, for example, a music searchlet 118, a books searchlet 120, and a shopping searchlet 122.

In the present exemplary operative scenario, the user has elected to try the shopping searchlet 122 by selecting it from the first searchlet pull-down menu 54 and by selecting the try-searchlet radio button 56. The user has typed the word widgets in the search field 60. Upon pressing the search button 52, underlying software (including browser software) supporting user interface associated with the third screen 100, activates a search, such as via a remote website. The shopping searchlet 122 is then automatically installed client side on a trial basis or is otherwise run on a trial basis server side, as discussed more fully below. The shopping searchlet 122 is then automatically applied to search results returned via the remote website. Alternatively, the shopping searchlet 122 selectively modifies parameters of a search before the search is initiated. Various searchlets implemented according to embodiments of the present invention are adaptable to various websites, such as Google®, Yahoo®, or Froogle®.

Furthermore, the searchlets may be adapted to websites that do not offer searches. In these cases, the searchlets 102 may conduct searches of documents, such as for key words or phrases, based on their own search engines. Those skilled in the art with access to the present teachings may readily implement searchlets as disclosed herein without undue experimentation.

Note that when selecting the search button 52, the user simultaneously initiates activation or installation of a searchlet on a trial basis and application of the searchlet to a desired search. Similarly, if the user selects the install-searchlet radio button 68 instead of the try-searchlet radio button 56 and then presses the search button 52, the user simultaneously activates installation and use of the searchlet. A user interface feature other than a button, such as a hyperlink or menu may be employed to activate simultaneous use and installation of a searchlet, without departing from the scope of the present invention.

The underlying software associated with the webpage 64 includes one or more routines for enabling use and installation of a searchlet with the click of a button, and further enables simultaneous use and installation of a searchlet on a trial basis with the click of a button, such as the search button 52.

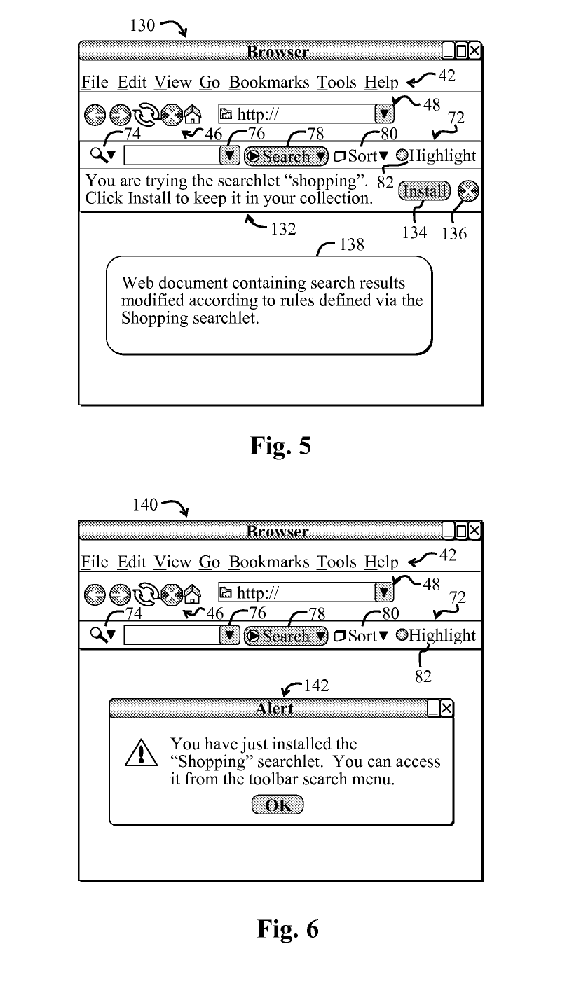

FIG. 5 is a diagram illustrating a fourth screen 130, which is accessed via the screen 100 of FIG. 4, for trying the shopping searchlet 122. The fourth screen 130 includes an additional toolbar 132, which is implemented via the base software associated with the first toolbar 72. Alternatively, the additional toolbar 132 is implemented via a website associated with the base software. The additional tool bar 132 includes an install button 134 and a dismiss button 136. The additional tool bar 132 may implement additional tools, buttons, and/or menus without departing from the scope of the present invention.

The fourth screen 130 displays a Web document 138, such as a webpage, that has been modified or otherwise affected by the shopping searchlet 122 that was selected in FIG. 4. If the user likes the results illustrated in the returned Web document 138, the user may install the shopping searchlet 122 as part of the base software by selecting the install button 134. The shopping searchlet 122 will then be added to the search toolbar 78. Otherwise, if the user selects the dismiss button 136, the shopping search let 122 will not become part of the search toolbar 78, and the trial of the shopping searchlet will terminate. If the user neither selects the install button 134 nor the dismiss button 136, the trial of the shopping searchlet 122 continues until is terminates based on predetermined trial rules, which may or may not be user configurable, depending on the embodiment implemented for a particular application.

FIG. 6. is a diagram illustrating a fifth screen 140 that appears when a user chooses to install the shopping searchlet 122 from any previous screens, such as the fourth screen 130 of FIG. 5 or the third screen 100 of FIG. 4. The fifth screen 140 displays an alert box 142 indicating that the user has just installed the shopping searchlet. The alert box 142 appears after the user selects the install button 134 of FIG. 5. The alert box 142 may overlay content, such as the Web document 138 of FIG. 5, without departing from the scope of the present invention.

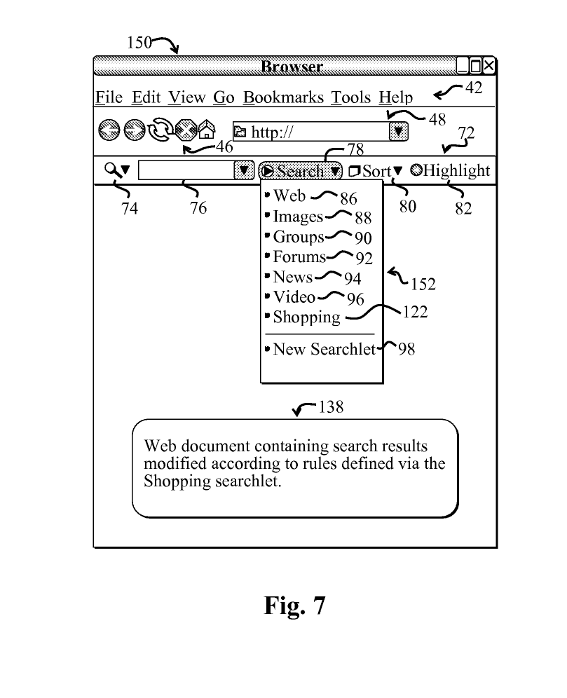

FIG. 7 is a diagram illustrating a sixth screen 150 and accompanying shopping searchlet menu option 122 that is accessible from the first tool bar 72 after installing the shopping searchlet 122. The menu option 122 graphically represents the shopping searchlet 122. The shopping searchlet 122 is included in a list 152 of installed searchlets, which are accessible via the search pull-down menu 78 of the first toolbar 72.

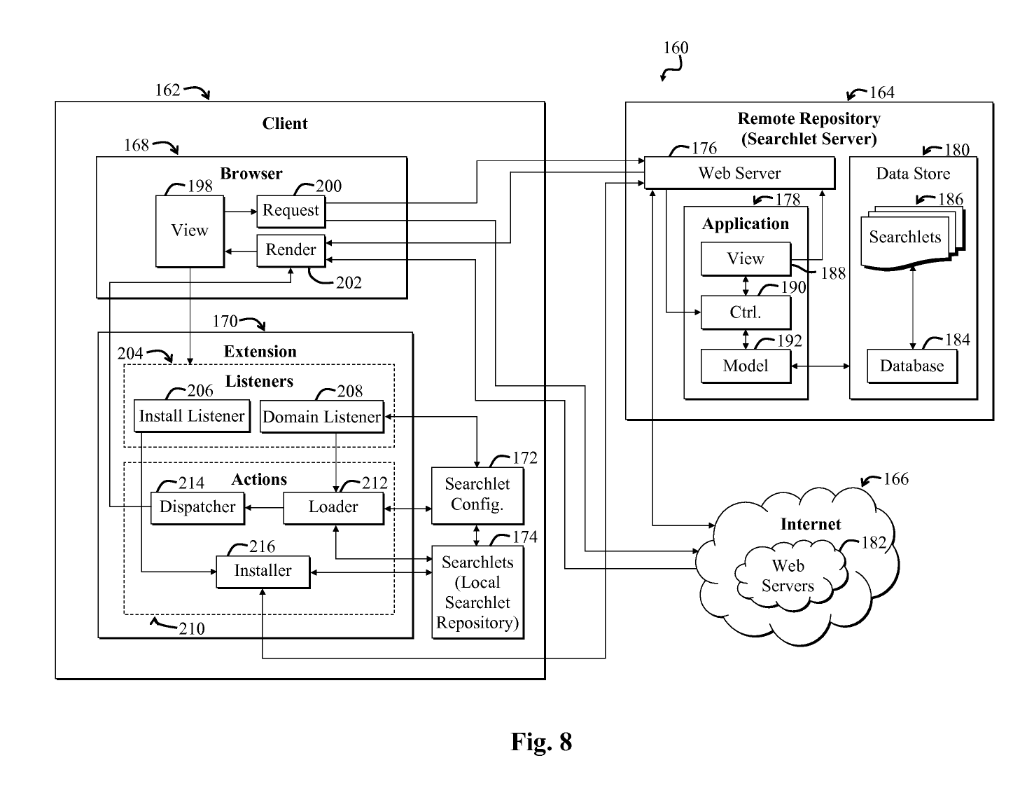

FIG. 8 is a diagram of a system 160 that employs a client 162 and a remote searchlet repository 164 for implementing the method 10 of FIG. 1 and accompanying screens 40, 70, 100, 130, 140, 150 of FIGS. 2-7, respectively. The client 162 includes a browser 168 in communication with a browser extension 170. The client 162 further includes a searchlet configuration module 172 in communication with a local searchlet repository 174. The searchlet configuration module 172 and local searchlet repository intercommunicated and further communicate with the browser extension 170.

The browser 168 and the browser extension 170 of the client 162 selectively communicate with the remote searchlet repository 164. The remote searchlet repository 163, which acts as a server for searchlets, includes a Web server 176 and an accompanying server application 178 that interfaces the Web server 176 with a data store 180. The data store 180 includes a database 184 and code corresponding to searchlets 186, which is accessible via the database 184. The server application 178 includes a view module 188, a control module 190, and a model module 192. The controller 190 may receive requests for action from the Web server 176. The requests may be requests for content, which may then be delivered to the model 192, which submits appropriate queries to the data store 180 and retrieves appropriate content from the data store 180 in response thereto. In the present embodiment, the view module 188 delivers content from the application 178 to the Web server 176 in preparation for sending the content to the client 162. Details of the remote searchlet repository 164 are shown for illustrative purposes only. The remote searchlet repository 164 may be implemented via different modules than those shown without departing from the scope of the present invention. Any suitable server that can provide searchlets in response to queries from the client 162 may be employed.

The client 162 and the remote searchlet repository 164 are connected to the Internet 166 in the present specific embodiment. The Internet 166 is shown including plural web servers 182, which may provide documents to which various searchlets may be applied.

The browser 168 of the client 162 includes a client-side view module 198, which interacts with the user, such as via the various screens 40, 70, 100, 130, 140, 150 of FIGS. 2-7, respectively. The view module 198 provides various requests to a request module 200, which may forward the requests other machines, such as the remote searchlet repository 164 or the Web servers 182 running on the Internet 166.

The view module 198 receives input from a render module 202. The render module 202 facilitates rendering screens and views in response to rendering instructions from the extension 170, the remote searchlet repository 164, or from other Web servers 182 running on the Internet 166.

The browser extension 170 includes listeners 204, including an install listener 206 and a domain listener 208. The listeners 204 may trigger various actions 210, associated with a loader 212, a dispatcher 214, and an installer 216. The loader 212 and domain listener 208 may communicate with the searchlet configuration module 172. The domain listener 208 may provide commands to the loader 212. The loader 212 and the installer 216 may further communicate with the local searchlet repository 174. The installer 216 may further communicate with the remote searchlet repository 164 directly or via requests for content sent via the browser 168 via an additional communication path (not shown).

In an exemplary operative scenario, the install listener 206 determines when a user has decided to install a searchlet. A corresponding signal indicating which searchlet is to be installed is then forwarded to the installer 216. The installer 216 then either retrieves code corresponding to the desired searchlet from the local searchlet repository 174 or from the remote searchlet repository 164. The desired configuration of the searchlet may accompany the searchlet or may be accessed by the installer 216 via the searchlet configuration module 172 by way of the local searchlet repository. If the installer 216 downloads the desired searchlet from the remote searchlet repository 164, then the downloaded searchlet is placed in the local searchlet repository 174.

The domain listener 208 may determine when a user chooses to try or otherwise install a searchlet and when a searchlet can be applied or should be applied to a particular document. The domain listener 208 may activate the loader 212, causing the loader 212 to load the desired searchlet and associated document to which to apply to searchlet. In certain embodiments, the domain listener 208 may also listen for user-configuration requests from the view module 198, wherein a user initiates requests to selectively adjust the configuration of a given searchlet. User configurable searchlet configuration information may include trial rules.

When loading the searchlet, the loader 212 may retrieve appropriate configuration information from the searchlet configuration module 172 to facilitate loading a given searchlet with the appropriate configuration parameters. The domain listener 208 may access the searchlet configuration module to help determine whether the configuration of a given searchlet will enable application of the searchlet to a particular document. The loader 212 may also communicate with the remote searchlet repository 164 without departing from the scope of the present invention.

The client 162 may make requests by interacting with the view module 198. The requests are monitored by the base software, represented by the extension 170, and facilitated by the appropriately loaded searchlet. The dispatcher 214 includes hooks to allow for modifications specified by the searchlet after loading. Requests to the remote searchlet repository 164 allow for installation, trial, or limited remote use of a variety of searchlets.

The request module 200 and the render module 202 include abstract layers for input/output and client interaction. Such modules are known in the art.

The domain listener 208 detects events after the current view is loaded via the view module 198. The domain listener 208 also determines if a particular searchlet should be loaded and run, and further determines on what basis or in what mode the searchlet should be run, such as trial mode or install mode.

The local searchlet repository 174 may handle the model and lifespan of a searchlet and may further maintain the searchlet configuration information represented by the searchlet configuration module 172.

The dispatcher 214 receives a searchlets from the loader 212 and sends documents with, which have been modified according to the searchlets, to the render for rendering and displaying via the view module 198.

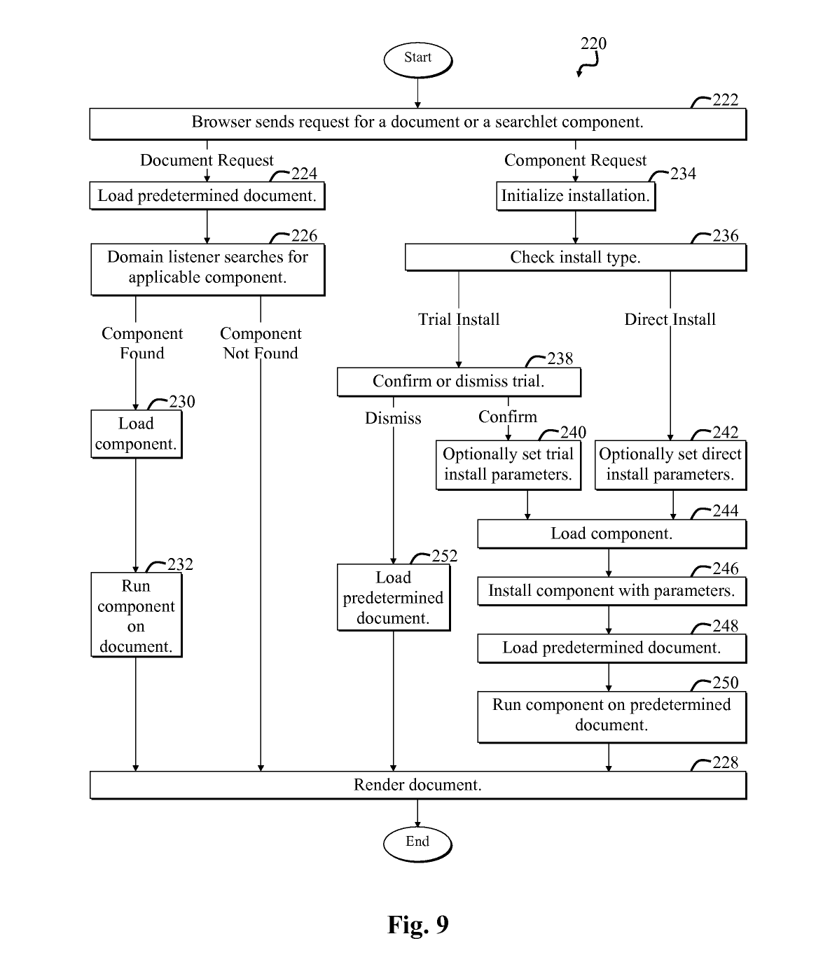

FIG. 9 is a diagram of a method 220 employed by the client 162 of FIG. 8 in response to a request to try or install a searchlet component or to apply a searchlet to a document. The method includes an initial browser request-sending step 222, wherein a browser, such as the browser 168 of FIG. 8, sends a request for a document or a searchlet, also called a searchlet component.

If the browser sends a document request, such as to the extension 170 of FIG. 8, the document is loaded in a first document-loading step 224.

Subsequently, in a domain-listening step 226, a corresponding domain listener, such as the domain listener 208 of FIG. 8, searches for an applicable searchlet component, such as via the local searchlet repository 174 of FIG. 8. If the domain listener does not find the searchlet component, then the loaded document is rendered without application of the searchlet component to the document. Document rendering occurs in a subsequent rendering step 228.

If in the domain-listening step 226, the domain listener finds the desired searchlet component, then the searchlet component is loaded in a subsequent component-loading step 230. The searchlet component is then run on the loaded document in a subsequent component-running step 232. The resulting document, after application of the searchlet component, is rendered via the document-rendering step 228.

If in the browser request-sending step 222, the browser sends a request for a component, such as to the extension 170 of FIG. 8, then an initialization step 234 is performed. The initialization step 234 includes initializing the installation of the searchlet component, which will either be installed on a trial basis or an install basis. For the purposes of the present discussion, an install basis may represent any installation wherein the searchlet component is installed without restrictions associated with a trial installation. Examples of restrictions associated with a trial installation include, but are not limited to, limits on duration of use, limits on how the searchlet can be used and from where it can be run, and so on.

A subsequent install-type determining step 236 determines whether the searchlet component is to be installed on a trial basis or on an install basis. If the searchlet component is to be installed on a trial basis, then a confirmation step 238 is performed.

The confirmation step 238 provides a user option to proceed with trying a searchlet component to dismiss the loading or trying of the searchlet component. Note that the answer as to whether a user has chosen to confirm or dismiss a given trial installation may be determined before implementation of the method 220, in which case, the confirmation step 238 merely accesses the predetermined information to determine program flow.

If the user chooses to dismiss the searchlet component, then a relevant document is loaded, in a second document-loading step 252, without application of the searchlet. The loaded document is then rendered via the rendering step 228.

If the user has chosen to proceed with a trial installation, then a first parameter-setting step 240 may be performed. The first parameter-setting step 240 may enable a user to set certain trial installation parameters, such as duration of use desired.

If the install-type determining step 236 determines that a direct install of a searchlet component is desired, then a second parameter-setting step 242 may be implemented before the component is loaded. The second parameter-setting step 242 may enable a user to set or choose certain installation parameters for a given searchlet. Exact installation parameters are application specific. Those skilled in the art will know which parameters to implement and may readily implement them for a given application without undue experimentation.

After setting of any installation parameters in the parameter-setting steps 240, 242, a second component-loading step 244 is performed, wherein the searchlet component is loaded based on predetermined parameters, including parameters indicating the type of installation, such as trial or install type.

Subsequently, the loaded searchlet component is installed, in accordance with the associated parameters, in a component-installing step 246.

Subsequently, a document is loaded in the third document-loading step 248, and the loaded searchlet component is run on the loaded document or otherwise applied thereto in a second component-running step 250. The resulting document is then rendered in the rendering step 228. After rendering of the document, the method 220 completes.

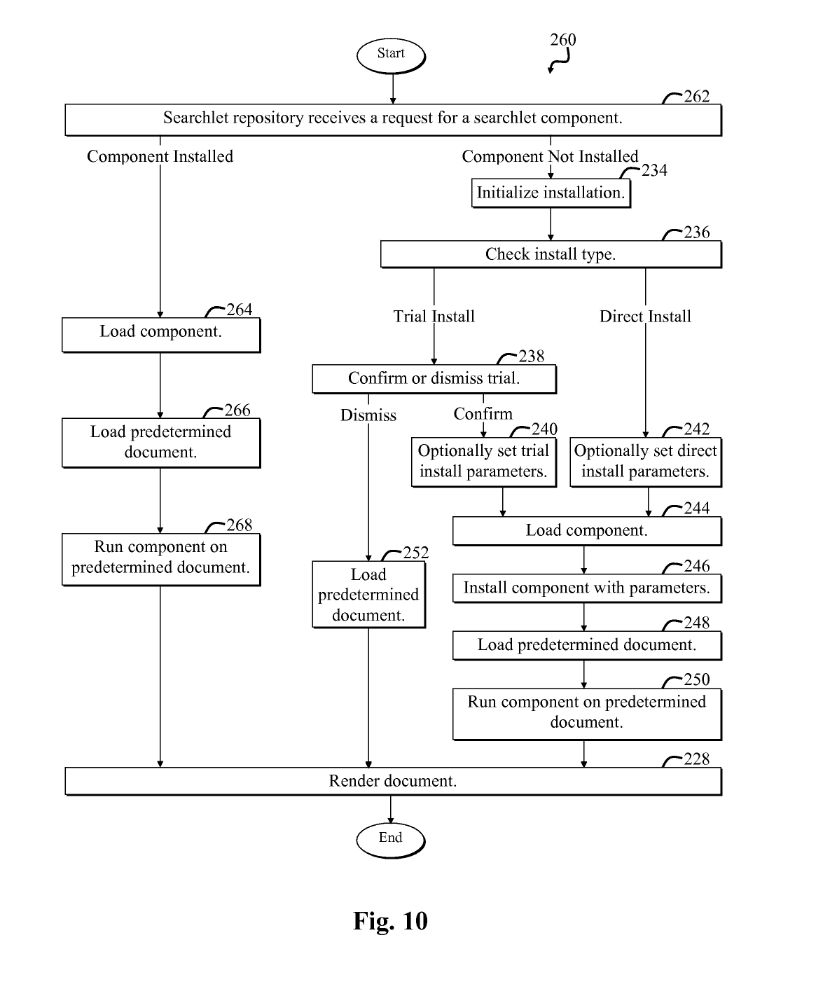

FIG. 10 is a diagram of a method 260 employed by the remote searchlet repository 164 or the local searchlet repository 274 and accompanying loader 212 of FIG. 8 in response to a request from the client of FIG. 8. The method 260 includes an initial component request-receiving step 262, wherein a request for a searchlet component is received, such as from the browser 168 of FIG. 8. If the requested component is not installed, then the portion of the method 260 represented by steps 234-252 and the rendering step 228 are performed. The steps 234-252, 228 of FIG. 10 are similar to the corresponding steps of FIG. 9.

If the component request-receiving step 262 determines that a requested component is already installed, the component is loaded in an initial component-loading step 264. A document is then loaded in an initial document-loading step 266. Then, the loaded component is run on the loaded document in an initial component-running step 268. The resulting document, having been modified by the searchlet component as desired, is then rendered in the subsequent rendering step 228.

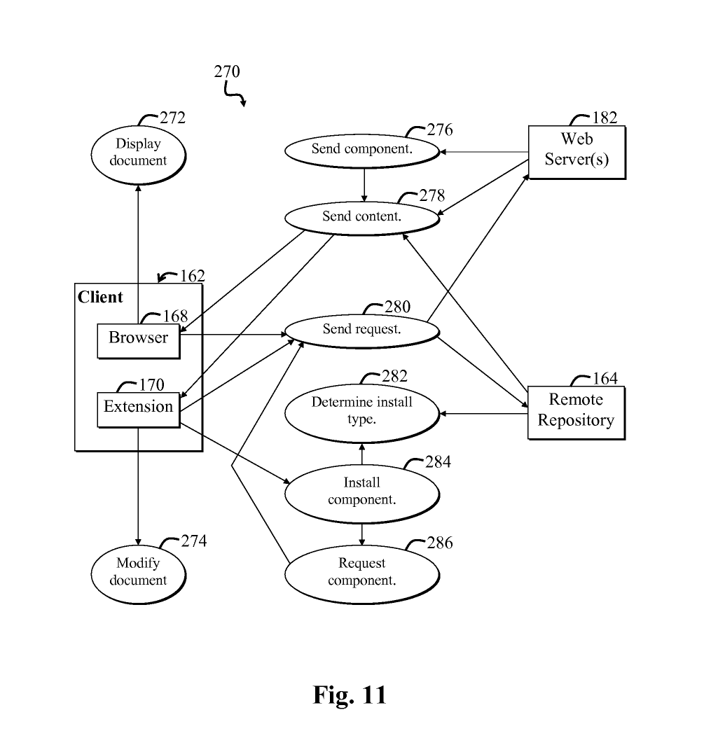

FIG. 11 is a use-case diagram 270 illustrating various functionality 272-286 implemented via various modules 162, 168, 170, 164, 182 of the system 160 of FIG. 8. The browser 168 may employ display-document functionality 272 and request-sending functionality 280. The request-sending functionality 280 includes functions used to send requests to the remote repository 164 and the web servers 182. The extension 170 may also employ the request-sending functionality 280 along with component-installing functionality 284.

The component-installing functionality 284 selectively employs component-requesting functionality 286 to then employ the request-sending functionality 280 to send component requests to the remote repository 164 or other Web servers 182. The component-installing functionality 284 may also employ install-type determining functionality 282, which may also be employed by the remote searchlet repository 164.

The remote searchlet repository 164 may employ content-sending functionality 278 to send content to the browser 168 and/or the extension 170 of the client 162. The Web servers 182 may also employ the content-sending functionality 278 and component-sending functionality 276 to send content and components to the client 162.

Although embodiments of the invention are discussed primarily with respect to systems and methods for selectively using searchlet components on a trial basis, embodiments of the present invention are not limited thereto. For example, embodiments of the present invention may be applied to software components other than searchlets without departing from the scope of the present invention. For example, when installing an operating system, certain operating system components could be used on a trial basis until a user choose to make the components automatically load each time an operating system is run. This could save computer resources in preventing unwanted components from loading each time an accompanying computer is booted.

Furthermore, any acceptable architecture, topology, protocols, or other network and digital processing features can be employed. In general, network modules, such as clients, servers, and so on, can be implemented via any device with processing ability or other requisite functionality.

Although processes of the present invention and the hardware executing the processes may be characterized by language common to a discussion of the Internet (e.g., “client,” “server,” etc.), it should be apparent that operations of the present invention can execute on any type of suitable hardware in any communication relationship to another device on any type of link or network.

Although a process of the present invention may be presented as a single entity, such as software executing on a single machine, such software can readily be executed on multiple machines. That is, there may be multiple instances of a given software program, a single program may be executing on two or more processors in a distributed processing environment, parts of a single program may be executing on different physical machines, etc. Furthermore, two different programs, such as a client and server program, can be executing in a single machine, or in different machines. A single program can be operating as a client for one information transaction and as a server for a different information transaction.

Any type of processing device can be used as a client. For example, portable computing devices such as a personal digital assistant (PDA), cell phone, laptop computer, or other devices can be employed. In general, the devices and manner of specific processing (including location and timing) are not critical to practicing important features of the present invention.

Although the invention has been discussed with respect to specific embodiments thereof, these embodiments are merely illustrative, and not restrictive, of the invention. Embodiments of the present invention can operate between any two processes or entities including users, devices, functional systems, or combinations of hardware and software. Peer-to-peer networks and any other networks or systems where the roles of client and server are switched, change dynamically, or are not even present are within the scope of the invention.

Any suitable programming language can be used to implement the routines or other instructions employed by various network entities. Exemplary programming languages include C, C++, Java, assembly language, etc. Different programming techniques can be employed such as procedural or object oriented. The routines can execute on a single processing device or multiple processors. The routines can operate in an operating system environment or as stand-alone routines occupying all, or a substantial part, of the system processing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “machine-readable medium” or “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” or “process” includes any human, hardware and/or software system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems. A computer may be any processor in communication with a memory.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Embodiments of the invention may be implemented in whole or in part by using a programmed general purpose digital computer; by using application specific integrated circuits, programmable logic devices, field programmable gate arrays, optical, chemical, biological, quantum or nanoengineered systems or mechanisms; and so on. In general, the functions of the present invention can be achieved by any means as is known in the art. Distributed or networked systems, components, and/or circuits can be used. Communication, or transfer of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow “a”, “an”, and “the” include plural references unless the context clearly dictates otherwise. Furthermore, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

1. A system adapted to selectively try software, the system including:
a browser; and
a software extension including:
a first listener adapted to determine if a desired component is available and usable on a predetermined document and adapted to provide a first signal in response thereto; and
one or more sub-extensions adapted to selectively load the desired component on a trial basis or a non-trial basis in response to the first signal and based on a predetermined configuration associated with the desired component.

2. The system of claim 1, wherein the system includes a client, which includes the browser.

3. The system of claim 2, wherein the desired component includes a searchlet.

4. The system of claim 3, wherein the client includes a local searchlet repository that is accessible via the software extension.

5. The system of claim 3, wherein the client is in communication with a remote searchlet repository.

6. The system of claim 2, wherein the client is in communication with one or remote servers, which are adapted to provide content to the client in response to one or more requests from the client.

7. The system of claim 2, wherein the browser includes a user interface, the user interface including: a search field and a component-selection menu, wherein the component-selection menu is adapted to provide a user option to select a component for affecting search results to be returned in response to a search defined via the search field.

8. The system of claim 7, wherein the user interface further includes one or more selectable fields that enable a user to specify a mode of operation for the component.

9. The system of claim 8, wherein the mode of operation includes a trial mode.

10. The system of claim 9, wherein the mode of operation includes an install mode.

11. The system of claim 8, wherein the desired component includes searchlet.

12. A method for providing a user option to select software operational mode, the system comprising:
activating base software that is adapted for use with one or more components;
providing a first user option to use a first component in a first mode of operation;
providing a second user option to use the first component with the base software in a second mode of operation; and
using the first component according to the first mode of operation or according to the second mode of operation based on whether the first user option or the second user option is selected.

13. A method for selectively trying software, the method comprising:
providing a user option to elect to use a software component on a trial basis or not;
accessing trial rules for a trial use of the software component if the user has elected to use the software component on a trial basis;
automatically enabling the user to selectively use the software component in accordance with the trial rules; and
installing the software component on a non-trial basis if the user has elected to install the software component and has elected not to use the software component on a trial basis.

14. The method of claim 13, further including:
providing a user option to run the software component via a client or a server.

15. The method of claim 13, further including:
installing the software component on a client and running the software component on the client when the software component runs on a non-trial basis.

16. The method of claim 13, further including:
running the software component on a server when the software component runs on a trial basis.

17. The method of claim 13, further including:
providing a user option to adjust the trial rules.

18. The method of claim 13, wherein the software component is a component of a base software application.

19. The method of claim 18, wherein the base software includes a Firefox™ extension.

20. The method of claim 19, wherein the software component includes a searchlet.

21. The method of claim 20, wherein installing the software component on a non-trial basis includes incorporating an option to access the searchlet from a toolbar associated with the base software.

22. The method of claim 13 further including:
automatically loading a file.

23. The method of claim 22, wherein the file includes a document.

24. The method of claim 23, wherein the document includes a webpage.

25. The method of claim 22, further including:
automatically applying the software component to the document.

26. The method of claim 25, further including:
rendering the document after application of the software component.

27. The method of claim 13, further including:
enabling a user to simultaneously use and install a searchlet in response to selecting a user-interface feature.

28. The method of claim 13, further including:
enabling a user to simultaneously use and install a searchlet on a trial basis in response to selecting a user-interface feature.

29. A system for providing a user option to select software operational mode, the system comprising:
first means for activating base software that is adapted for use with one or more components;
second means for providing a first user option to use a first component in a first mode of operation;
third means for providing a second user option to use the first component with the base software in a second mode of operation; and
fourth means for using the first component according to the first mode of or operation or the second mode of operation based on output from the second means or the third means.

30. The system of claim 29, wherein the first mode of operation includes a trial mode, and wherein the second mode of operation includes an install mode.

31. The system of claim 30, wherein the trial mode is characterized by an automatic expiration of a predetermined trial period.

32. The system of claim 30, wherein the trial mode is characterized by expiration of trial period if the first component is not used a predetermined number of times during a predetermined interval.

33. The system of claim 30, wherein the trial mode switches to install mode, thereby triggering automatic installation of the first component, when the first component is used a predetermined number of times over a predetermined time period.

34. The system of claim 30, wherein the first component includes one or more software components that include one or more searchlets.

35. The system of claim 29, wherein the first means includes a client.

36. The system of claim 35, wherein the first means further includes a browser running on the client, wherein the client is in communication with a server, and wherein content of the server is accessible via the browser.

37. The system of claim 35, wherein the first mode of operation includes a mode wherein the first component is usable on a trial basis without requiring that the first component be installed on the client as part of the base software.

38. The system of claim 37, further including:
fourth means for providing a user option to adjust one or more usage parameters associated with the first mode of operation, wherein the usage parameters affect a trial period for use of the first component.

39. The system of claim 38, wherein the one or more usage parameters include a parameter that specifies an expiration time for use of the first component.

40. The system of claim 31, wherein the second means includes software running on a server that is accessible by the client.

41. The system of claim 31, wherein the first component includes one or more components that include one or more software extensions.

42. The system of claim 41, wherein the one or more software extensions include Firefox™ extensions.
